(19) United States
(12) Patent Application Publication
(10) Pub. No.: US 2006/0088672 A1
(43) Pub. Date: Apr. 27, 2006

(54) Ink jet recording sheet

(76) Inventors: Kazuo Totani, Tokyo (JP); Hirokazu Sunagawa, Tokyo (JP); Satoshi Matsuura, Chiba-shi (JP); Naho Kinoshita, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/257,701

(22) Filed: Oct. 25, 2005

(30) Foreign Application Priority Data
Oct. 27, 2004 (JP) P2004-312570

(51) Int. Cl. B41M 5/40

(52) U.S. Cl. 428/32.3

(57) ABSTRACT

The present invention relates to an ink jet recording sheet comprising: a supporting medium; and an ink receiving layer formed on the supporting medium, wherein the ink receiving layer comprises a pigment, an adhesive agent, an ink fixing agent, and a ternary copolymer comprising an alkyl (meth)acrylate, an N-methylolacrylamide, and a styrene.

### CROSS-REFERENCE TO RELATED APPLICATIONS

The present invention claims priority to Japanese Patent Application No. 2004-312570, filed on Oct. 27, 2004, the content of which is incorporated herein by reference.

### BACKGROUND OF THE INVENTION

1. Field of the Invention

The present invention relates to ink jet recording sheets.

2. Description of the Related Art

Ink jet recording systems in which ink is ejected through a nozzle having fine pores to form an image on a recording medium are widely used in terminal printers, facsimiles, plotters, sheet feeding printers, or the like, due to their low noise during recording, ease of forming full-color images, possibility of performing high-speed recording, lower cost than other printing devices, and so forth.

Moreover, in recent years, the demand for printed matter (ink jet-printed matter) printed using ink jet recording systems has rapidly increased as media having design properties such as large-sized posters, displays, or leaflets, and the printed matter are also becoming used as large-sized posters displayed outdoors, and so forth.

Accordingly, ink jet recording sheets are now required to have higher recording characteristics such as, for example, characteristics in which the print image is not discolored by the influence of light, ozone existing in the air, or the like (printing preservability such as print light resistance or print ozone resistance), and in which feathering is not caused by dropped water (print water resistance), in addition to clearness and high concentration of print image (coloring property).

Aqueous ink is generally used for the ink jet recording systems, and the aqueous ink is classified as a dye ink using a dye and a pigment ink using a pigment.

Now the dye ink is mainly used from the viewpoints of clearness of print images, and most generally available ink jet recording sheets are suitable for use with a dye ink.

However, the dye ink is easily oxidized by ultraviolet rays, ozone, or the like, and the print light resistance and the print ozone resistance thereof are low. Therefore, ink jet printed matter using dye ink is pointed out to have problems in which print preservability is not sufficient because the print image is discolored and deteriorated in its appearance during exhibition, and the use of pigment ink having excellent light resistance and ozone resistance is increasing.

However, the pigment ink is inferior in clearness of print image compared with the dye ink as described above, and the clearness is significantly deteriorated when the pigment ink is used to print something on the ink jet recording sheets for dye ink.

Accordingly, ink jet recording sheets are required which can exhibit excellent recording characteristics even when printed with dye ink as well as pigment ink. As a method for obtaining an ink jet recording sheet which exhibits excellent suitability for dye ink as well as pigment ink, various methods have been proposed, such as a method in which a water-soluble metal salt is included in a coating solution (see, for example, Japanese Laid-Open Patent Application No. 2002-274022), a method in which two or more coating layers are formed (see, for example, Japanese Laid-Open Patent Application No. 2000-94831, Japanese Laid-Open Patent Application No. 2000-168228, Japanese Laid-Open Patent Application No. 2002-347330, Japanese Laid-Open Patent Application No. Hei 10-278411), a method in which roughness of a coating layer surface is adjusted to a particular value (see, for example, Japanese Laid-Open Patent Application No. 2000-158804), a method in which a pigment having a specific particle diameter is included in a coating layer (see, for example, Japanese Laid-Open Patent Application No. 2001-270238), a method in which a coating layer is formed by a porous organic resin having a specific pore radius, pore capacity, and pH within a specific range (see, for example, Japanese Laid-Open Patent Application No. 2001-246841), or the like.

However, ink jet recording sheets described in the above-mentioned patent documents have problems in their coloring property, such as, for example, insufficient concentration of print image obtained by using either dye ink or pigment ink.

### SUMMARY OF THE INVENTION

The present invention relates to an ink jet recording sheet including: a supporting medium; and an ink receiving layer formed on the supporting medium, wherein the ink receiving layer includes a pigment, an adhesive agent, an ink fixing agent, and a ternary copolymer containing an alkyl (meth)acrylate, an N-methylolacrylamide, and a styrene.

The ink receiving layer may further include a water-soluble metal salt. The water-soluble metal salt may be at least one of zinc chloride and zinc sulfate.

The ink receiving layer may further include a silica surface-treated with a surfactant.

### DETAILED DESCRIPTION OF THE INVENTION

The present invention has been achieved in consideration of the above-mentioned situation, and relates to an ink jet recording sheet excellent in coloring property for dye ink as well as pigment ink. In particular, the present invention relates to a mat type ink jet recording sheet satisfying the above-mentioned quality.

As a result of accumulated investigation, the inventors of the present invention have found that the above-mentioned problems can be solved by using particular ternary copolymers, and completed the present invention.

In the following, the present invention summarized above and defined by the enumerated claims will be explained in detail. This detailed description of particular preferred embodiments, set out below to enable one to build and use particular implementation of the invention, is not intended to limit the enumerated claims, but to serve as particular examples thereof.

<<Layer Structure>>

An ink jet recording sheet according to the present invention has a supporting medium and an ink receiving layer containing particular components and disposed on the supporting medium.

The ink receiving layer may be provided on both sides of the supporting medium. In such a case, it becomes possible to provide a clear print image on both sides of the ink jet recording sheet.

Also, the ink receiving layer may be formed by a plurality of layers. An undercoat layer may be formed between the supporting medium and the ink receiving layer, and an overcoat layer may be formed on the ink receiving layer so as to improve the preservability provided that the recording suitability of the ink receiving layer is not impaired.

<<Supporting Medium>>

There is no particular limitation imposed on the supporting medium as long as it is a medium which can be used for an ordinary ink jet recording sheet. Examples thereof include paper, such as woodfree paper, art paper, coated paper, cast-coated paper, foil paper, craft paper, baryta paper, impregnated paper, and vapor deposition paper; resin films, one generally known as synthetic paper in which at least one paper-like layer formed by a uniaxially-drawn resin or biaxially-oriented resin is laminated on a base material layer such as paper, nonwoven fabrics, and resin-coated paper, such as one in which a resin film is attached to coated paper or woodfree paper via an adhesive agent, and one in which a resin is laminated on paper.

<<Ink Receiving Layer>>

The ink receiving layer contains a pigment, an adhesive agent, an ink fixing agent, and a ternary copolymer composed of alkyl (meth)acrylate, N-methylolacrylamide, and styrene. It is preferable that the ink receiving layer includes a water-soluble metal salt, particularly at least one zinc compound selected from zinc chloride and zinc sulfate.

<Pigment>

There is no particular limitation imposed on the pigment as long as it is a pigment which can be used for a coating layer or an ink receiving layer of a conventional ink jet recording sheet. Examples thereof include inorganic pigments, such as silica, soft calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, aluminum hydroxide, alumina, pseudoboehmite, lithopone, zeolite, hydrated halloysite, magnesium carbonate, and magnesium hydroxide; and organic pigments made of resins, such as an acryl or methacryl resin, a vinyl chloride resin, a vinyl acetate resin, a polyester resin, a styrene-acryl resin, a styrene-butadiene resin, a styrene-isoprene resin, a polycarbonate resin, a silicone resin, a urea resin, a melamine resin, an epoxy resin, a phenol resin, and a diallylphthalate resin. These pigments may be in a spherical form or in an amorphous form, and may be non-porous or porous. Also, these pigments may be used singularly or in a combination of two or more.

Among these pigments, it is preferable to use silica, alumina, pseudoboehmite, soft calcium carbonate, and zeolite due to their excellent coloring and ink absorbing properties. Among them, it is more preferable to use silica, alumina, and pseudoboehmite, and it is most preferable to use silica.

As for the above-mentioned silica, use of amorphous silica is preferable. Methods for producing the silica are not particularly limited, and it may be produced by using an arc method, a dry method, a wet method (precipitation method, gel method), and so forth. Among these methods, the wet method is preferable since the silica produced by the method is suitable for both of the ink jet recording sheet for dye ink and the ink jet recording sheet for pigment ink.

When wet type silica is used, the average particle size of the secondary particle of the wet silica is preferably 2 to 12 μm, and more preferably 4 to 10 μm. If the average particle size of the secondary particle of the wet silica is less than 2 μm in the ink jet recording sheet for dye ink, the absorbing property for dye ink of the ink jet recording sheet tends to decrease. Also, since the light transmittance of the ink jet recording sheet tends to increase, the light resistance of images formed by dye ink and the coating strength tend to decrease. Also, when such a silica is used for the ink jet recording sheet for pigment ink, disadvantages such as lowering in the fixation property of the pigment ink may be caused.

If the average particle size of the secondary particle of the wet silica exceeds 12 μm, on the other hand, problems tend to be caused for both the ink jet recording sheet for dye ink and the ink jet recording sheet for pigment ink, such as lowering in clearness of image and the generation of image blurring due to surface roughness.

Note that the term “average particle size of silica” in this application is measured using a call counter method, and it indicates a volume average particle size measured using a sample of silica which is ultrasonically dispersed in distilled water for 30 seconds.

According to the present invention, it is preferable that the surface of at least a part of the pigment contained in the ink receiving layer be treated with a surfactant. That is, the surface of all of the pigment may be treated with a surfactant, or it is possible to use the surface treated pigment together with untreated pigment. The untreated pigment is the same as those explained above, and hence the explanation thereof will be omitted.

As the pigment whose surface is treated with a surfactant, it is possible to use the same pigments as described above, and it is preferable to use silica, alumina, pseudoboehmite, soft calcium carbonate, and zeolite. Among them, it is more preferable to use silica, alumina, and pseudoboehmite, and it is most preferable to use silica as described above.

Although the surfactant used for treating the surface of the pigment is not particularly limited, it is preferable to use a nonionic surfactant. Examples thereof include polyoxyethylenealkyl ether, polyoxyethylene polyoxypropylene copolymer, polyoxyethylene polyoxypropylene alkylether, and the like. Among these, one having a hydrophile-lipophile balance (HLB) value of 8.0 to 15.0 is preferable, and one having HLB value of 10.0 to 12.0 is more preferable.

As a method for treating the surface of the pigment using the surfactant, one which is described in, for example, Japanese Laid-Open Patent Application No. Hei 9-25440 may be adopted. That is, a dry mixing method may be adopted in which the pigment, for example, wet type silica, and the surfactant, for example, polychain type nonionic surfactant, are mixed using a mixer, such as a high-speed stream mixer. In such a case, it is possible to add the surfactant directly to the pigment, and it is also possible to add the surfactant which is diluted with a volatile solvent, such as ethanol, to the pigment and mix these.

Moreover, it is possible to adopt a wet treatment method in which a predetermined amount of the surfactant, for example, the nonionic surfactant is added and mixed with an emulsion slurry solution of the pigment, for example, wet type silica, and a spray-drying process is subsequently carried out. In the wet treatment method, if the surfactant is insoluble in water, it is preferable to strongly disperse the surfactant in water to form an emulsion in advance, sequentially add the emulsion to an emulsified slurry solution of the pigment to be sufficiently mixed, and then carry out a drying process.

The surface of the silica which is treated with the surfactant using the method described above is considered to be covered by the surfactant.

The amount of the surfactant added is preferably 0.1 to 30 parts, more preferably 0.5 to 20 parts, with respect to 100 parts of pigment. When silica covered by the surfactant within the above-mentioned range is used, the coloring property is improved and clear images can be obtained

<Adhesive Agent>

The adhesive agent used in the ink receiving layer is not particularly limited, and it is possible to use conventionally known adhesive agents which are generally used for ink jet recording. Examples thereof include proteins, such as casein, soy bean protein, and synthesized protein; various starches, such as ordinary starch and oxidized starch; polyvinyl alcohol and derivatives thereof; cellulose derivatives, such as carboxymethyl cellulose and methyl cellulose; conjugated diene resins such as styrene-butadiene resin and methyl methacrylate-butadiene copolymer; acryl resins which are polymers or copolymers of acrylic acid, methacrylic acid, acrylate, methacrylate, etc.; and vinyl resins, such as ethylene-vinyl acetate copolymer. Among them, it is specifically preferable to use polyvinyl alcohol or derivatives thereof due to good coating suitability exhibited when used together with the ternary copolymer composed of alkyl (meth)acrylate, N-methylolacrylamide, and styrene. These adhesive agents may be used singularly or in combination of two or more.

<Ink Fixing Agent>

The ink fixing agent used in the ink receiving layer is not particularly limited, and it is possible to use conventionally known ink fixing agents which are generally used for ink jet recording. Examples thereof include water-soluble metal salts, cationic polymers, and the like. These ink fixing agents may be used singularly or in combination of two or more.

Examples of the water-soluble metal salt include: 1) water soluble salts (nitrate, chloride, acetate, sulfate, lactate, etc.) of aluminum; 2) water soluble salts (chloride, sulfate, nitrate, acetate, lactate, etc.) of magnesium; 3) water soluble salts (nitrate, chloride, acetate, sulfate, lactate, etc.) of sodium; 4) water soluble salts (nitrate, chloride, acetate, sulfate, lactate, etc.) of potassium; and 5) water soluble salts (chloride, sulfate, nitrate, acetate, lactate, etc.) of zinc, which are commercially available.

Examples of the cationic polymer include: 1) polyalkylene polyamines or derivatives thereof, such as polyethylene amine and polypropylene polyamine; 2) acryl resins having a secondary amine group, a tertiary amine group, and/or a quaternary ammonium group; 3) polyvinyl amine, polyvinyl amidine, and 5-member ring amidines; 4) dimethylamine-epichlorohydrin copolymer, 5) diallyldimethyl ammonium-SO₂ copolymer, 6) diallylamine salt-SO₂ copolymer, 7) dimethyldiallyl ammonium chloride copolymer, 8) polymer of allylamine salt, 9) dialkylaminoethyl(meth)acrylate quaternary salt copolymer, 10) acrylamide-diallylamine copolymer, which are commercially available.

Among these ink fixing agents, it is particularly preferable to contain the water-soluble metal salt. Using the water-soluble metal salt together with the ternary copolymer composed of alkyl (meth)acrylate, N-methylolacrylamide, and styrene enables an improvement in coloring property of the dye ink as well as pigment ink, and particularly, a significantly clear image can be obtained when printed using pigment ink, though the exact reasons why such improvements can be achieved are not known.

Among the water-soluble metal salts, zinc compounds, particularly zinc chloride, and zinc sulfate are preferably selected due to their excellent ink absorbing property and clearness of image.

The amount of the water-soluble metal salt is adjusted to be 3 to 40 parts by mass, preferably 5 to 35 parts by mass, with respect to 100 parts by mass of the pigment. If the amount of the water-soluble metal salt is less than 3 parts by mass, coloring of the image, particularly printed using pigment ink, tends to be deteriorated. If the amount of the water-soluble metal salt is more than 40 parts by mass, deterioration of the ink absorbing property, generation of image blurring, deterioration of clearness of image, and deterioration of print water resistance tend to be caused.

<Ternary Copolymer>

According to the present invention, the ink receiving layer contains the ternary copolymer composed of alkyl (meth)acrylate, N-methylolacrylamide, and styrene.

Examples of alkyl (meth)acrylate include methyl (meth)acrylate, ethyl (meth)acrylate, n-propyl (meth)acrylate, iso-proply (meth)acrylate, n-butyl (meth)acrylate, iso-butyl (meth)acrylate, tert-butyl (meth)acrylate, n-amyl (meth)acrylate, iso-amyl (meth)acrylate, hexyl (meth)acrylate, 2-ethylhexyl (meth)acrylate, octyl (meth)acrylate, iso-nonyl (meth)acrylate, decyl (meth)acrylate, dodecyl (meth)acrylate, tridecyl (meth)acrylate, stearyl (meth)acrylate, and the like, and these may be used singularly or in combination of two or more. Among these, from the viewpoint of production stability, one having an alkyl group including 1 to 12 carbon atoms is particularly preferable.

The glass transition temperature of the ternary copolymer is preferably −80 to +50° C., and more preferably −50 to +30° C. When the glass transition temperature is less than −80° C., the ink absorbing property tends to decrease. When the glass transition temperature is more than +50° C., the cracking resistance of the coating layer tends to deteriorate.

The amount of alkyl (meth)acrylate is preferably 5 to 90 parts by mass with respect to 100 parts by mass of the ternary copolymer. The amount of N-methylolacrylamide is preferably 5 to 90 parts by mass with respect to 100 parts by mass of the ternary copolymer. The amount of styrene is preferably 5 to 90 parts by mass with respect to 100 parts by mass of the ternary copolymer. If the amount of alkyl (meth)acrylate is less than 5 parts by mass, the cracking resistance of the coating layer tends to deteriorate, as a result of which cracking of the coating layer will easily occur. If the amount of alkyl (meth)acrylate is more than 90 parts by mass, deterioration of the ink absorbing property and generation of image blurring tend to be caused. If the amount of N-methylolacrylamide is less than 5 parts by mass, deterioration of the ink absorbing property and generation of image blurring tend to be caused. If the amount of N-methylolacrylamide is more than 90 parts by mass, the cracking resistance of the coating layer tends to deteriorate, as a result of which cracking of the coating layer or loss of powder from the surface of the coating layer will easily occur. If the amount of styrene is less than 5 parts by mass, the frictional strength tends to decrease, as a result of which loss of powder from the surface of the coating layer will easily occur. If the amount of styrene is more than 90 parts by mass, deterioration of the ink absorbing property and generation of image blurring tend to be caused. The ternary copolymer may be a block copolymer or a random copolymer.

The amount of the ternary copolymer composed of alkyl (meth)acrylate, N-methylolacrylamide, and styrene is preferably 5 to 50 parts by mass, more preferably 10 to 30 parts by mass, with respect to 100 parts by mass of the pigment. If the amount of the ternary copolymer is less than 5 parts by mass, the surface strength of the coating layer tends to decrease, as a result of which the loss of powder from the surface of the coating layer and cracking of the coating layer tend to easily occur. If the amount of the ternary copolymer is more than 50 parts by mass, deterioration of the ink absorbing property and generation of image blurring tend to be caused.

The amount of the ternary copolymer composed of alkyl (meth)acrylate, N-methylolacrylamide, and styrene is preferably 40 to 160 parts by mass, more preferably 80 to 120 parts by mass, with respect to 100 parts by mass of the adhesive agent. When the amount of the ternary copolymer is adjusted within such a range, the coloring property is improved, and clear images can be obtained.

<Other Optional Components>

It is possible to add various auxiliary agents, which are generally used for producing coated paper, in a suitable amount, to the ink receiving layer, such as a thickener, an antifoamer, a wetting agent, a surfactant, a coloring agent, an antistatic agent, a light resistance auxiliary agent, an UV absorber, an antioxidizing agent, and an antiseptic agent.

<<Method for Producing the Ink Jet Recording Sheet>>

Although the coating amount of the ink receiving layer is not particularly limited, it is preferably 2 to 30 g/m², and more preferably 5 to 20 g/cm². If the coating amount is less than the above-mentioned lower limit, the ink absorbing property, the clearness of images, and the print preservability tend to be easily deteriorated. If the coating amount is more than the above-mentioned upper limit, the coating strength and the clearness of image tend to be deteriorated.

The ink receiving layer may be formed by a plurality of layers, and in such a case, the component of each of the ink receiving layers may be the same or different from each other.

The ink receiving layer may be formed by using various known application devices, such as a blade coater, an air knife coater, a roll coater, a bar coater, a gravure coater, a rod blade coater, a lip coater, a curtain coater, and a die coater. It is possible to carry out a finishing process using a calender device, such as a machine calender, a super calender, and a soft calender.

According to the present invention, the ink jet recording sheet, specifically a mat type ink jet recording sheet, can be obtained which is excellent in coating surface strength, print water resistance, image concentration, ink absorbing property, and coloring property for dye ink as well as pigment ink. Moreover, since a paper base material made of a pulp recycled from waste paper can be used as the supporting medium according to the present invention, it is possible to effectively utilize limited natural resources.

Moreover, its is possible to produce a label by providing an adhesive layer on the back surface of the ink jet recording sheet of the present invention as well as to produce a magnetic card or an IC card by providing a magnetic layer or an IC chip on the ink jet recording sheet of the present invention.

### EXAMPLES

Hereinafter, the present invention will be explained in more detail with reference to Examples. However, it is apparent that the present invention is not limited to these Examples. Also, “parts” and “%” used in the examples indicate “parts by mass” and “% by mass” of a solid component excluding water unless otherwise so indicated.

### Example 1

<Preparation of Surface-Treated Silica A>

To 900 g of wet silica (manufactured by Tokuyama Corporation under the product name of Finesil X-60) suspended in water to obtain slurry (about 10 to 15%), 100 g of a water-suspension of a surfactant (polyoxyethylenelauryl ether manufactured by Dai-ichi Kogyo Seiyaku Co. Ltd., under the product name of Noigen ET-102, HLB: 10.8) was added. The mixture was stirred for one hour, spray-dried, pulverized, and classified to obtain the surface-treated silica A of the present invention. The average secondary particle size of the obtained surface-treated silica A was 6 μm.

<Preparation of Ink Receiving Layer Coating Solution>

An ink receiving layer coating solution was prepared by mixing and dispersing 80 parts of wet silica (manufactured by Tokuyama Corporation under the product name of Finesil X-60) and 20 parts of the surface-treated silica A obtained as described above as pigment, 20 parts of silyl denatured PVA (manufactured by Kuraray Co. Ltd., under the product name of R-1130) as an adhesive agent, 10 parts of zinc sulfate aqueous solution (manufactured by Wako Pure Chemical Industries., used as a 5% solution prepared by dissolving zinc sulfate heptahydrate in water) as an ink fixing agent, 20 parts of n-butyl acrylate-N-methylolacrylamide-styrene copolymer (emulsion type) as a ternary copolymer, and water.

<Preparation of Ink Jet Recording Sheet>

The ink receiving layer coating solution was applied onto a surface of woodfree paper having a basis weight of 170 g/m² so that the coating amount became 10 g/m², and was then dried to obtain an ink jet recording sheet.

Each obtained ink jet recording sheet was evaluated based on the following criteria. The evaluated results are shown in Table 1.

### Example 2

An ink jet recording sheet was prepared in the same manner as described in Example 1 except that 10 parts of zinc chloride aqueous solution (manufactured by Wako Pure Chemical Industries., used as a 5% solution prepared by dissolving zinc chloride heptahydrate in water) were used instead of the zinc sulfate aqueous solution contained in the ink receiving layer coating solution of Example 1.

### Example 3

An ink jet recording sheet was prepared in the same manner as described in Example 1 except that 10 parts of magnesium chloride aqueous solution (manufactured by Wako Pure Chemical Industries., used as a 5% solution prepared by dissolving magnesium chloride hexahydrate in water) were used instead of the zinc sulfate aqueous solution contained in the ink receiving layer coating solution of Example 1.

### Example 4

An ink jet recording sheet was prepared in the same manner as described in Example 1 except that 10 parts of magnesium sulfate aqueous solution (manufactured by Wako Pure Chemical Industries., used as a 5% solution prepared by dissolving magnesium sulfate heptahydrate in water) were used instead of the zinc sulfate aqueous solution contained in the ink receiving layer coating solution of Example 1.

### Example 5

An ink jet recording sheet was prepared in the same manner as described in Example 1 except that 5 parts of zinc sulfate aqueous solution (manufactured by Wako Pure Chemical Industries., used as a 5% solution prepared by dissolving zinc sulfate heptahydrate in water) and 5 parts of dicyandiamide-polyethylene amine copolymer (manufactured by Nicca Chemical Co. Ltd., under the product name of Neofix IJ-117) were used instead of the ink fixing agent contained in the ink receiving layer coating solution of Example 1.

### Example 6

An ink jet recording sheet was prepared in the same manner as described in Example 1 except that 100 parts of wet silica (manufactured by Tokuyama Corporation under the product name of Finesil X-60) were used instead of the pigment contained in the ink receiving layer coating solution of Example 1.

### Example 7

An ink jet recording sheet was prepared in the same manner as described in Example 1 except that 8 parts of n-butyl acrylate-N-methylolacrylamide-styrene copolymer (emulsion type) were used instead of the ternary copolymer contained in the ink receiving layer coating solution of Example 1.

### Example 8

An ink jet recording sheet was prepared in the same manner as described in Example 1 except that 40 parts of n-butyl acrylate-N-methylolacrylamide-styrene copolymer (emulsion type) were used instead of the ternary copolymer contained in the ink receiving layer coating solution of Example 1.

### Example 9

An ink jet recording sheet was prepared in the same manner as described in Example 1 except that 5 parts of zinc sulfate aqueous solution were used instead of 10 parts of zinc sulfate aqueous solution contained in the ink receiving layer coating solution of Example 1.

### Example 10

An ink jet recording sheet was prepared in the same manner as described in Example 1 except that 35 parts of zinc sulfate aqueous solution were used instead of 10 parts of zinc sulfate aqueous solution contained in the ink receiving layer coating solution of Example 1.

### Example 11

An ink jet recording sheet was prepared in the same manner as described in Example 1 except that 20 parts of n-octyl acrylate-N-methylolacrylamide-styrene copolymer (emulsion type) were used instead of the ternary copolymer contained in the ink receiving layer coating solution of Example 1.

### Comparative Example 1

An ink jet recording sheet was prepared in the same manner as described in Example 1 except that 20 parts of vinyl acetate-based polymer (manufactured by Nissin Chemical Industry Co., Ltd., under the product name of Vinyblan 1080, emulsion type) were used instead of the ternary copolymer contained in the ink receiving layer coating solution of Example 1.

### Comparative Example 2

An ink jet recording sheet was prepared in the same manner as described in Example 1 except that 20 parts of acrylic resin (manufactured by Rohm and Haas Co. Ltd., under the product name of Primal P-376) were used instead of the ternary copolymer contained in the ink receiving layer coating solution of Example 1.

### Comparative Example 3

An ink jet recording sheet was prepared in the same manner as described in Example 1 except that 20 parts of SBR (manufactured by JSR Co. Ltd., under the product name of 0589, Tg: 0° C., emulsion type) were used instead of the ternary copolymer contained in the ink receiving layer coating solution of Example 1.

### Comparative Example 4

An ink jet recording sheet was prepared in the same manner as described in Example 1 except that 20 parts of styrene acrylate copolymer (manufactured by Clariant Polymers K.K., under the product name of Movinyl 880, Tg: 3° C., emulsion type) were used instead of the ternary copolymer contained in the ink receiving layer coating solution of Example 1.

### Comparative Example 5

An ink jet recording sheet was prepared in the same manner as described in Example 1 except that 20 parts of styrene polymer (manufactured by Daicel FineChem Ltd., under the product name of Cevian A 47050, emulsion type) were used instead of the ternary copolymer contained in the ink receiving layer coating solution of Example 1.

<<Evaluation>>

Print concentration, feathering, surface strength, and cracking resistance of the ink jet recording sheets obtained in Examples 1 to 11 and Comparative Examples 1 to 5 were evaluated using the methods described below.

The evaluation was made by printing on the ink jet recording sheet using commercially available ink jet printers A to C described below.

(Printer A)

A commercially available ink jet printer (manufactured by SEIKO EPSON Corporation under the trade name of PM-G800; ink: dye ink, print mode: Photomat paper/high fineness).

(Printer B)

A commercially available ink jet plotter (manufactured by SEIKO EPSON Corporation under the trade name of PX-9000; ink: pigment ink/Mat black; print mode: PXMC premium mat paper/clean).

(Printer C)

A commercially available ink jet plotter (manufactured by Hewlett-Packard Co., under the trade name of Design Jet 5500PS; ink: pigment ink; print mode: best quality).

(Print Concentration)

An image issued by Japanese Standards Association (“high fineness color digital standard image XYZ/JIS-SCID”, Identification Number: S6; Image title: Color Chart) was printed using the above-mentioned three types of printers A to C, and the print concentration of the best black tone portion was measured using a “RD-914” measuring device manufactured by Gretag Macbeth Co.

(Feathering)

An image issued by Japanese Standards Association (“high fineness color digital standard image XYZ/JIS-SCID”, Identification Number: S6; Image title: Color Chart) was printed using printer A, and the degree of feathering was visually evaluated based on the following criteria:

∘: most excellent;

∘-: slightly inferior, but sufficient for practical use;

Δ: inferior; and

x: most inferior.

(Materials evaluated as ∘ or ∘- are suitable for practical use.)

(Surface Strength)

Each surface of the ink jet recording sheets was scratched with a nail, and the strength thereof was visually evaluated based on the following criteria:

∘: most excellent;

∘-: slightly inferior, but sufficient for practical use;

Δ: inferior; and

x: most inferior.

(Materials evaluated as ∘ or ∘- are suitable for practical use.)

(Cracking Resistance)

Each ink jet recording sheet was folded in four, unfolded, and the cracked state of a central portion where the two creases intersected was visually evaluated based on the following criteria:

∘: most excellent;

∘-: slightly inferior, but sufficient for practical use;

Δ: inferior; and

x: most inferior.

(Materials evaluated as ∘ or ∘- are suitable for practical use.)

TABLE 1

| | Print concentration | | | Feathering | | |
|---|---|---|---|---|---|---|
| | Printer A | Printer B | Printer C | Printer A | Surface | Cracking |
| | (dye ink) | (pigment ink) | (pigment ink) | (dye ink) | strength | Resistance |
| Ex. 1 | 1.94 | 1.82 | 1.65 | ◯ | ◯ | ◯ |
| Ex. 2 | 1.93 | 1.81 | 1.64 | ◯ | ◯ | ◯ |
| Ex. 3 | 1.88 | 1.78 | 1.60 | ◯ | ◯ | ◯ |
| Ex. 4 | 1.87 | 1.77 | 1.60 | ◯ | ◯ | ◯ |
| Ex. 5 | 1.87 | 1.77 | 1.59 | ◯ | ◯ | ◯ |
| Ex. 6 | 1.92 | 1.80 | 1.62 | ◯ | ◯ | ◯ |
| Ex. 7 | 1.93 | 1.82 | 1.64 | ◯ | ◯− | ◯− |
| Ex. 8 | 1.90 | 1.80 | 1.58 | ◯− | ◯ | ◯ |
| Ex. 9 | 1.90 | 1.80 | 1.60 | ◯ | ◯ | ◯ |
| Ex. 10 | 1.92 | 1.80 | 1.62 | ◯− | ◯ | ◯ |
| Ex. 11 | 1.94 | 1.82 | 1.65 | ◯ | ◯ | ◯ |
| C. Ex. 1 | 1.75 | 1.72 | 1.58 | ◯ | ◯ | ◯ |
| C. Ex. 2 | 1.78 | 1.75 | 1.58 | ◯ | Δ | ◯ |
| C. Ex. 3 | 1.79 | 1.74 | 1.57 | ◯ | ◯ | ◯ |
| C. Ex. 4 | 1.80 | 1.75 | 1.58 | ◯ | ◯ | ◯ |
| C. Ex. 5 | 1.78 | 1.75 | 1.58 | ◯ | ◯ | ◯ |

As is clearly shown in Table 1 above, each of the ink jet recording sheets of Examples 1 to 11 in which the ink receiving layer includes the ternary copolymer composed of alkyl (meth)acrylate, N-methylolacrylamide, and styrene, in addition to the pigment, the adhesive agent, and the ink fixing agent, exhibited high print concentration and excellent coloring property for dye ink as well as pigment ink, and produced clear images. Also, the ink jet recording sheets of Examples 1 to 11 were excellent at preventing feathering, and had high surface strength and excellent cracking resistance.

On the other hand, the ink jet recording sheets prepared in Comparative Examples 1 to 5 without using the ternary copolymer according to the present invention exhibited low print concentration and were inferior in clearness of images.

Thus, the ink jet recording sheet according to the present invention is excellent in coloring property for dye ink as well as pigment ink, and can clearly print high quality fine images, and particularly can exhibit the above-mentioned effects in mat type.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An ink jet recording sheet comprising:
a supporting medium; and
an ink receiving layer formed on the supporting medium, wherein
the ink receiving layer comprises a pigment, an adhesive agent, an ink fixing agent, and a ternary copolymer comprising an alkyl (meth)acrylate, an N-methylolacrylamide, and a styrene.

2. An ink jet recording sheet according to claim 1, wherein the ink receiving layer further comprises a silica surface-treated with a surfactant.

3. An ink jet recording sheet according to claim 1, wherein the ink receiving layer further comprises a water-soluble metal salt.

4. An ink jet recording sheet according to claim 3, wherein the ink receiving layer further comprises a silica surface-treated with a surfactant.

5. An ink jet recording sheet according to claim 3, wherein the water-soluble metal salt is at least one of zinc chloride and zinc sulfate.

6. An ink jet recording sheet according to claim 5, wherein the ink receiving layer further comprises a silica surface-treated with a surfactant.
